(19) United States
(12) Patent Application Publication
(10) Pub. No.: US 2025/0005529 A1
(43) Pub. Date: Jan. 2, 2025

(54) Dynamic Logic Generator for Incongruous Information in Construction Project Planning Applications

(71) Applicant: Procore Technologies, Inc., Carpinteria, CA (US)

(72) Inventors: Garett Bynum, St. Louis, MO (US); Sourabh Suri, Vancouver (CA); Youngmin Jeong, Salinas, CA (US); Chetan Kale, Sunnyvale, CA (US)

(21) Appl. No.: 18/345,960

(22) Filed: Jun. 30, 2023

(51) Int. Cl. G06Q 10/10; G06N 20/00

(52) U.S. Cl. CPC G06Q 10/103; G06N 20/00; G06Q 50/08

(57) ABSTRACT

A computing platform is configured to: (i) generate a logical flowchart for a construction project task, the logical flowchart based on at least one incongruous rule and at least one incongruous data set; (ii) generate a text-based graphical user interface (GUI) prompt based on the logical flowchart; (iii) cause the text-based GUI prompt to be presented via one or more of the first client station, the second client station, or combinations thereof; (iv) receive, from a client station, an indication of user input to the text-based GUI prompt; and (v) cause the text-based GUI prompt to present output information, via the first client station, based on the logical flowchart and the user input.

### BACKGROUND

Construction projects are often complex endeavors involving the coordination of many professionals across several discrete phases. Such projects have multiple planning and building phases that occur as part of, for example, a workflow. The planning phases may involve contract bidding, contractor selection, project feasibility studies, regulatory approval and/or permitting, among other known planning phases.

Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as HVAC, plumbing, electrical, etc., and produce plans reflecting these designs as well.

After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction or implementation phase, construction professionals begin to construct the project based on the finalized plans.

Such construction planning, design, and implementation produces a vast amount of information related to a construction project which is then utilized by many different construction professionals in many ways, throughout the lifecycle of the construction project. To alleviate some of the burden involved with handling such vast amounts of information, software technology has been developed to enable electronic management of information associated with a construction project.

### OVERVIEW

As mentioned above, software technology has been developed to enable computing platforms to ingest and store information associated with construction projects in an effort to facilitate electronic management of construction project information. However, the construction industry, as a whole, remains susceptible to various inefficiencies related to processing this vast amount of information. Particularly, many issues arise, both on back-end (administrator or platform holder) design of applications and on the user end use of such applications, due to both the nature of data input and the potential incongruity of the data.

Certain forms of information, data, and/or logical processing associated with a construction project are easily processed in a logical flow, with the information being translatable or otherwise easily converted for another task. For example, such translatable information may be data that can be held in a one-to-one data correlation (e.g., language translation, cost conversions, substitute components, etc.) that can be, for example, stored in a simple look-up-table (LUT) on a server. Alternatively, an example of easily translatable logic associated with a construction task may be simple formulas or functions applied to a dataset that convert said data into another form; such functional logic may include, but is not limited to including, cost conversions (e.g., exchange rates), material wear specifications, company pay scales, among other conventional, translatable functions or logic.

However, much of the data collected or desired for planning a construction project or a task thereof may be introduced as incongruous rules and/or incongruous data sets. “Incongruous rules,” as defined herein, refers to any functions, relationships, or methods for determining data that does not follow concise, easily repeatable rules and that, generally, would require direct user input for each query posed to said rule, absent prior user-input. Thus, easy, user-friendly systems and methods for translating data via incongruous rules are not easily programmed in a way that covers most construction scenarios, absent significant user intervention. Examples of incongruous rules may include, but are not limited to including, regulatory constraints associated with a locality or jurisdiction, environmental constraints associated with a locality or area, local tax codes or business regulations affecting pay in local or hyper-local areas, workflow constraints based on local labor regulations, among other rules or logic that are not easily determined without direct user input.

Similarly, incongruous data sets, as defined herein, refer to any data pairs or data groups that do not follow a simple, predictable, one-to-one translation, based on known or previously stored data (e.g., a LUT, language translation data, etc.) and, thus, incongruous data sets rely on direct user input or partial user input, based on a portion of the data set being a prompt to a user. Therefore, easy, user-friendly systems for obtaining or translating data via incongruous data sets is not easily integrated into a construction management software application, absent significant user input. Examples of incongruous data sets may include, but are not limited to including, vehicle lists and characteristics thereof, localities and associated restrictions, construction project timing data, user-defined part replacement suggestions, etc.

Incongruous rules and/or incongruous data sets can often be encountered or needed in planning a workflow for a construction project and/or a construction project task thereof. A “workflow” may refer to a plan or organization scheme for a construction project that includes an ordering and listing of tasks for the construction project. A workflow may assign specifics tasks, approvals, and/or review actions to one or more participants in said construction project. While current software for generating and/or managing workflows do aid in assisting contractors and/or other participants in a construction project in managing a project, certain inefficiencies arise when incongruous rules and/or data sets are either introduced or desired in generating or evaluating a workflow.

To that end, the inventions and embodiments disclosed herein aim to introduce logic and/or generate dynamic logic databases associated with incongruous rules and data sets. Logical flowchart and/or workflow generation systems and methods will, generally, perform a first step of either presenting an end user (e.g., a Procore Technologies customer) with one or more pre-prepared logical flow charts. Additionally or alternatively, the systems and methods will prompt a user to generate a logical flowchart associated with one or more incongruous rules or datasets. Data will be recorded of the customer user's decision, whether selecting a pre-formed logical flowchart template or generating a new logical flowchart. If the user generates a new logical flowchart, the new logical flowchart and the inter-relation of the logical blocks therein are recorded on a platform server or database. Optionally, the new logical flowchart and/or its component logical blocks may have an associative tag generated or labeled, such that the platform holder can sort the user-generated logical flowchart (e.g., associating a new logic flow with the application it is used with).

As another possibility, the logical blocks within a given logical flowchart may be saved as respective nodes in a graph database that includes edges connecting the node to other nodes that are related nodes. In this regard, each edge connecting to a given node may represent an instance where the logical block was used as part of a logical flowchart. This process may continue until the end user completes his/her/their logical process, all the while, the data and logic formats are sorted by the system and fed back into the platform, for use in enhancing predictability in automating workflow process generation, for evaluating patterns in logical flowcharts created by users, for collecting data associated with certain localities, for generating rules databases based on locality-based workflow conditions, for generating cause/effect rules based on regulatory constraints, among other things.

Location and localization make template generation or “one-size-fits-all” workflow templates nearly impossible, due to the sheer scale of incongruous rules and data sets that are introduced when trying to convert a first workflow in a first locality to a second workflow in a second locality. Accordingly, workflows often must account for local regulations. A customer user may utilize pre-determined rule sets, that are already stored in a backend server, if that has already been populated for a given locality, via input logical flowcharts. Alternatively, the customer user may have another tool or a different tool for generating a new flowchart based on the effects of local regulations on his/her/their worksite, related to his/her/their specific locality, which is then fed back into the database for future use by both platform-holder users and customer users. This results in a user-friendly application for workflow creation that allows a user to customize workflows, for a specific locality, via their user input or via an automated filling in of rules for regulations at a locality, that were prior input by a separate user (or the platform) and fed into the platform database.

Returning to the difficulties introduced by incongruous rules based on location, but rather than analyzing for local regulations, either GPS or other location based data can be utilized to determine environmental and/or infrastructure based conditions that may affect a construction work flow. For example, a location of a work site may have weight restrictions at certain locations (roads, bridges, etc.) that limit the kind of heavy machinery that can travel to the worksite. If tools in a workflow are generated based on known, local, restrictions-which may be input via the logical flowcharts of the instant disclosure-then this may optimize a hyper localization tool for enhancing workflows.

Further still, tax code or tax payment information is another example of how “rules” are incongruous and differ, particularly on a local level (regardless of the scale of “local,” be it nation, state, province, county, municipality, etc.). This is particularly applicable to the broader, rules/input based model, which feeds into the back end, as a user may be capable of inputting their local tax code rules into a rules engine, which then feeds into the backend server; while, alternatively, if the tax form for the locale is already known by the back end, that simplifies the system for the end user.

While the incongruous rules and datasets input by users, as discussed above, are certainly valuable in generating logical flowcharts, then providing for re-use of said logical flowcharts, as will be discussed in more detail below, the flowcharts and data thereof may also be utilized by machine learning models. By using machine learning models, the input incongruous rules and data sets can be compiled into databases and/or clusters of incongruous datasets and rules, which can then be evaluated for one or more of utilizing predictions to provide suggestions in a workflow, or other application, and/or generate new logical flowcharts and/or predicted incongruous datasets, based on the previously input data and rules.

Such predictions may be useful in risk mitigation, either in generating a workflow or for other tasks platform-wide. For example, tools utilizing said flowcharts may recognize sequences of events in a workflow that, generally, cause a negative outcome (e.g., increased project cost, project delay, etc.) and, either via data compilation or machine learning, generate a “risk detection” mechanism that can be utilized when analyzing an end user's workflow. For example, utilizing sequential data fed back into the platform server, the platform may notice that, if EVENT B follows EVENT A in a workflow, a negative outcome has a higher likelihood of occurring. Thus if this statistically significant risk detection occurs, utilization of prior data that illustrates these faults are used as another tool.

As defined herein, a “construction project” refers to any building, construction, demolition, and/or removal of a structure, public or private infrastructure, landscaping, greenery, or otherwise large scale movement or construction of property on real estate. A “construction project task” refers to one or more sub-divided tasks associated with the defined construction project, which may be one of a planning task, an engineering task, and/or a construction task, among other possibilities.

In line with the discussion above, the disclosed technology may be implemented as one or more software applications that facilitate the creation and management of data during the course of a construction project, some examples of which may include the types of software applications developed by Procore Technologies. Further, in practice, the computing platform in which the disclosed technology is incorporated may take the form of a software as a service (“SaaS”) application that comprises a front-end software component running on a user's client station and a back-end software component running on a back-end computing platform that is accessible to the user client station via a communication network such as the Internet.

In one aspect, disclosed herein is a method that involves a computing platform (i) generating a logical flowchart for a construction project task, the logical flowchart based on at least one incongruous rule and at least one incongruous data set, (ii) generating a text-based graphical user interface (GUI) prompt based on the logical flowchart, (iii) causing the text-based GUI prompt to be presented via one or more of the first client station, the second client station, or combinations thereof, (iv) receiving, from the first client station or the second client station, an indication of user input to the text-based GUI prompt, (v) causing the text-based GUI prompt to present output information, via the first client station, based on the logical flowchart and the user input, and (vi) storing, at least, the output information on at least one non-transitory computer readable medium of the computing platform. Each incongruous rule comprises a respective initial condition and one or more respective response conditions, each of the respective initial condition and the one or more respective response conditions being one of previously received from a first client station associated with a first user, being previously input from the first client station or a second client station, being populated via current user input to the second client station, or combinations thereof. The at least one incongruous data set includes one or more first datum and one or more second datum, each of the one or more first datum correlated with one of the one or more second datum, each of the one or more first datum, the one or more second datum, and correlations thereof being one of previously received from a first client station associated with a first user, being previously input from the first client station or a second client station, being populated via current user input to the second client station, or combinations thereof. Each of the at least one incongruous rule, the at least one incongruous data set, the initial condition, the one or more response conditions, the one or more first datum, and the one or more second datum are associated with the construction project task.

In some example embodiments, the method further includes selecting a template logical flowchart from a plurality of template logical flowcharts and generating the logical flowchart for the construction project task is based on the template logical flowchart.

In some example embodiments, the first user of the first client station is a first platform-side user and generating the logical flowchart for the construction project task is based on platform-side input.

In some example embodiments, the first user of the first client station is a first platform-side user, generating the logical flowchart for the construction project task is based on platform-side input, and the method further includes the platform-side input from the first client station.

Further, in example embodiments, the second user of the second client station is a second platform-side user, and the method further includes (i) storing the logical flowchart on a platform generated flowchart database of the computing platform, (ii) utilizing, by the second platform-side user using the second client station, the logical flowchart for generating the text-based GUI prompt within a construction planning application that is executed by the computing platform.

In some example embodiments, the first user is a first construction-side user and the method further includes causing the computing platform to present the first user with an input GUI program on the first client station, the input GUI program for receiving the incongruous rules as input incongruous rules, the incongruous data sets as input incongruous data sets, or combinations thereof, from the first user, each of the input incongruous rules and incongruous data sets associated with a construction project, and (ii) receiving the input incongruous rules, input incongruous data sets, or combinations thereof from the first user via the input GUI program.

Further, in example embodiments, the second user is a platform-side user of the computing platform, and the method further includes (i) storing the logical flowchart on a user-generated flowchart database of the computing platform, and (ii) utilizing, by the second user, the logical flowchart for generating another text-based GUI prompt within a construction planning application that is executed by the computing platform.

Further, in other example embodiments, the second user is a second construction-side user of the computing platform and the method further includes (i) storing the logical flowchart on a user-generated flowchart database of the computing platform and (utilizing, by the second user, the logical flowchart for generating another text-based GUI prompt within a construction planning application that is executed by the computing platform.

In some example embodiments, the second user of the computing platform is a construction-side user of the computing platform, the method further includes causing the second client station to present the second user with a workflow generation application, causing the text-based GUI prompt to be presented to one or more of the user of the computing platform, another user of the computing platform, or combinations thereof is performed within the workflow generation application, and the output information is associated with a workflow for the construction task.

In some example embodiments, each of the at least one incongruous rule, the at least one incongruous data set, the initial condition, the response condition, the one or more datum, and the one or more second datum are associated with one or more of a geographical location for the construction task, a local jurisdiction for the construction task, or combinations thereof.

Further, in example embodiments, at least one of the at least one incongruous rule, the at least one incongruous data set, the initial condition, the response condition, the one or more datum, and the one or more second datum is associated with a local regulation of the local jurisdiction for the construction task.

In another aspect, disclosed herein is a computing platform that includes a network interface, at least one processor, a non-transitory computer-readable medium, and program instructions stored on the non-transitory computer-readable medium that are executable by the at least one processor to cause the computing platform to carry out the functions disclosed herein, including but not limited to the functions of the foregoing method.

In yet another aspect, disclosed herein is a non-transitory computer-readable storage medium provisioned with software that is executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions according to the disclosed technology.

FIG. 3 depicts a structural diagram of an example end-user device that may be configured to communicate with the example computing platform of FIG. 2 and also carry out one or more functions in accordance with the disclosed technology.

FIG. 4 depicts a flow diagram of an example process for generating a logical flowchart that may be utilized by an example computing platform, utilizing incongruous rules and/or incongruous data sets, according to one possible implementation of the disclosed technology.

FIG. 5 depicts a graphic representation of the incongruous rules and incongruous data sets of FIG. 4, according to one possible implementation of the disclosed technology.

FIG. 6 depicts an example logical flowchart, as generated via the method of FIGS. 4-6, according to FIGS. 4-5 and one possible implementation of the disclosed technology.

FIG. 7A depicts a first, text-based graphic user interface (GUI) prompt, as generated by the method of FIGS. 4-6 based on, at least, the example logical flowchart of FIG. 6, according to FIGS. 4-6 and one possible implementation of the disclosed technology.

FIG. 7B depicts a second, text-based graphic user interface (GUI) prompt, as generated by the method of FIGS. 4-7A based on, at least, the example logical flowchart of FIG. 6, according to FIGS. 4-7A and one possible implementation of the disclosed technology.

FIG. 7C depicts a third, text-based graphic user interface (GUI) prompt, as generated by the method of FIGS. 4-7B based on, at least, the example logical flowchart of FIG. 6, according to FIGS. 4-7B and one possible implementation of the disclosed technology.

FIG. 8 depicts a flow diagram break down of a step of receiving input for generating the logical flowchart of FIG. 4, according to FIG. 4 and one possible implementation of the disclosed technology.

FIG. 9A depicts a first computing environment diagram representative of the computing platform of FIGS. 1-8 and a first use case of said computing platform, according to one possible implementation of the disclosed technology.

FIG. 9B depicts a second computing environment diagram representative of the computing platform of FIGS. 1-9A and a second use case of said computing platform, according to one possible implementation of the disclosed technology.

FIG. 9C depicts a computing environment diagram representative of the computing platform of FIGS. 1-9B and a third use case of said computing platform, according to one possible implementation of the disclosed technology.

FIG. 10 depicts a flow diagram of an example process for utilizing input incongruous data sets, incongruous rules, and/or generated logical flowcharts, with a machine-learning model for generating suggestions in an application of the computing platform, according to one possible implementation of the disclosed technology.

FIG. 11 depicts a flow diagram breaking down an example machine-learning model training step of the process of FIG. 10, according to one possible implementation of the disclosed technology.

FIG. 12A depicts a first GUI representation of a workflow application, for possible utilization in context of the process of FIGS. 10-11, according to one possible implementation of the disclosed technology.

FIG. 12B depicts a second GUI representation of a workflow application, for possible utilization in context of the process of FIGS. 10-12A, according to one possible implementation of the disclosed technology.

FIG. 13 depicts a first logical flowchart, generated in accordance with the disclosed technology, related to incongruous rules and data sets associated with localities and vehicles, according to one possible implementation of the disclosed technology.

FIG. 14 depicts a first logical flowchart, generated in accordance with the disclosed technology, related to incongruous rules and data sets associated with localities and regulations, according to one possible implementation of the disclosed technology.

FIG. 15 depicts a first logical flowchart, generated in accordance with the disclosed technology, related to incongruous rules and data sets associated with employment and tax information, according to one possible implementation of the disclosed technology.

FIG. 16 depicts a flow diagram for a process for utilizing the incongruous rules, incongruous data sets, output of prior disclosed processes, and/or other data disclosed herein, in assessing risk for a construction project managed via the computing platform and presenting a user with a suggestion, based on said determined risk, according to one possible implementation of the technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. EXAMPLE NETWORK CONFIGURATION

As one possible implementation, this software technology may include both front-end software running on one or more end-user devices that are accessible to users of the software technology and back-end software running on a back-end computing platform (sometimes referred to as a “cloud” platform or a “data” platform) that interacts with and/or drives the front-end software, and which may be operated (either directly or indirectly) by a provider of the front-end client software (e.g., Procore Technologies, Inc.). As another possible implementation, this software technology may include front-end client software that runs on end-user devices without interaction with a back-end platform (e.g., a native software application, a mobile application, etc.). The software technology disclosed herein may take other forms as well.

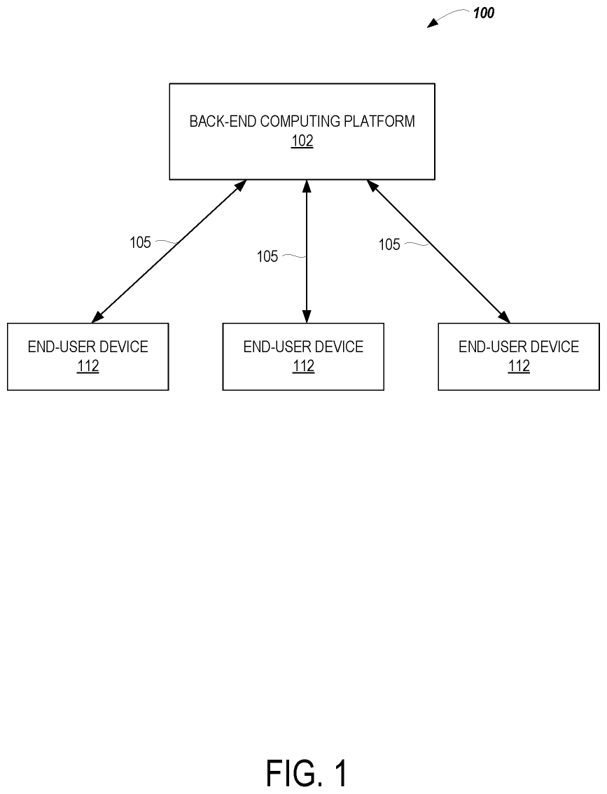

Turning now to the figures, FIG. 1 depicts an example network configuration 100 in which example embodiments of the present disclosure may be implemented. As shown in FIG. 1, the network configuration 100 includes an example back-end computing platform 102 that may be communicatively coupled to one or more client stations, depicted here, for the sake of discussion, as three end-user devices 112.

In practice, the back-end computing platform 102 may generally comprise some set of physical computing resources (e.g., processors, data storage, communication interfaces, etc.) that are utilized to implement the new software technology discussed herein. This set of physical computing resources may take any of various forms. As one possibility, the back-end computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the back-end computing platform 102 may comprise “on-premises” computing resources of the organization that operates the back-end computing platform 102 (e.g., organization-owned servers).

As yet another possibility, the back-end computing platform 102 may comprise one or more dedicated servers have been provisioned with software for carrying out one or more of the computing platform functions disclosed herein, including but not limited to functions related to processing incongruous rules and/or data sets, receiving incongruous rules and data sets, executing and/or training machine-learning models, identifying location entities, determining interrelationships between location entities and/or relationships between location entities and construction projects, generating data structures that can be used to organize information about identified location entities and their associated relationships, or causing the information about identified location entities and their associated relationships to be presented by the one or more end-user devices 112. The one or more computing systems of the back-end computing platform 102 may take various other forms and be arranged in various other manners as well.

In turn, end-user devices 112 may take any of various forms, examples of which may include a desktop computer, a laptop, a netbook, a tablet, a smartphone, and/or a personal digital assistant (PDA), among other possibilities.

As further depicted in FIG. 1, the back-end computing platform 102 may be configured to communicate with the end-user devices 112 over respective communication paths 105. Each communication path 105 between the back-end computing platform 102 and an end-user device 112 may generally comprise one or more communication networks and/or communications links, which may take any of various forms. For instance, each respective communication path 105 with the back-end computing platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 105 with the back-end computing platform 102 may be wireless, wired, or some combination thereof, and may carry data according to any of various different communication protocols. Although not shown, the respective communication paths with the back-end computing platform 102 may also include one or more intermediate systems. For example, it is possible that the back-end computing platform 102 may communicate with a given end-user device 112 via one or more intermediary systems, such as a host server (not shown). Many other configurations are also possible.

Although not shown in FIG. 1, the back-end computing platform 102 may also be configured to receive data from one or more external data sources that may be used to facilitate functions related to the processes disclosed herein. For example, the back-end computing platform 102 may be configured to incongruous rules and incongruous data from users and use said input to generate logical flowcharts, associated text-based GUI prompts, execute and train machine-learning models, among other things.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. EXAMPLE COMPUTING DEVICES

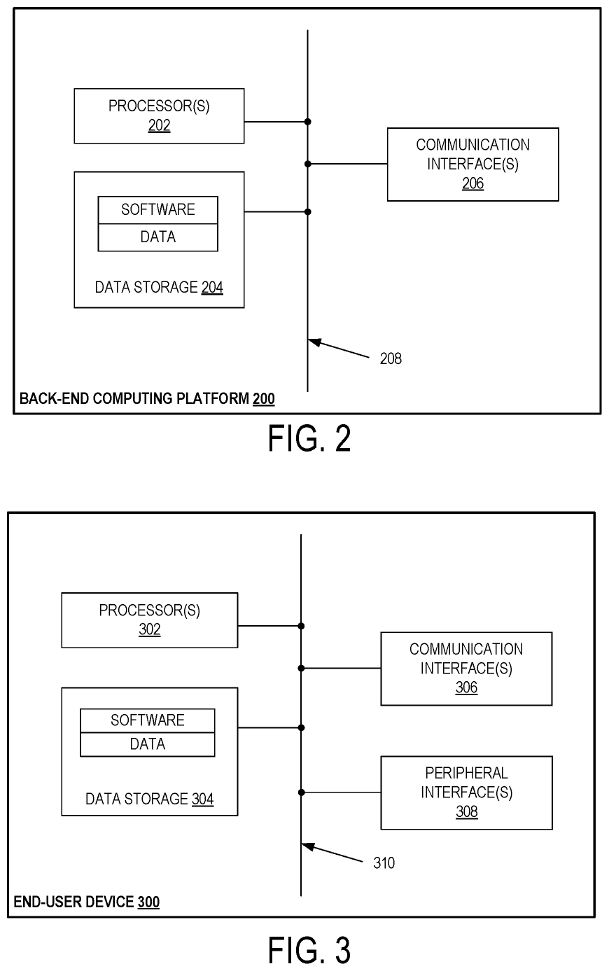

FIG. 2 is a simplified block diagram illustrating some structural components that may be included in an example computing platform 200. The example computing platform 200 could serve as, for instance, the back-end computing platform 102 of FIG. 1 that may be configured to create and/or run the disclosed data science models for receiving and processing incongruous rules and/or incongruous data sets. In line with the discussion above, the computing platform 200 may generally comprise one or more computer systems (e.g., one or more servers), and these one or more computer systems may collectively include at least one or more processors 202, a data storage 204, and one or more communication interfaces 206, all of which may be communicatively linked by a communication link 208 that may take the form of a system bus, a communication network such as a public, private, or hybrid cloud, or some other connection mechanism.

The one or more processors 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that the one or more processors 202 could comprise processing components that are distributed across a plurality of physical computing resources connected via a network, such as a computing cluster of a public, private, or hybrid cloud.

In turn, the data storage 204 may comprise one or more non-transitory computer-readable storage mediums that are collectively configured to store (i) program instructions that are executable by the one or more processors 202 such that the computing platform 200 is configured to perform some or all of the disclosed functions and (ii) data that may be received, derived, or otherwise stored, for example, in one or more databases, file systems, or the like, by the computing platform 200 in connection with the disclosed functions. In this respect, the one or more non-transitory computer-readable storage mediums of the data storage 204 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 204 may comprise computer-readable storage mediums that are distributed across a plurality of physical computing resources connected via a network, such as a storage cluster of a public, private, or hybrid cloud. Data storage 204 may take other forms and/or store data in other manners as well.

The one or more communication interfaces 206 may be configured to facilitate wireless and/or wired communication with external data sources and/or end-user devices, such as the end-user devices 112 in FIG. 1. Additionally, in an implementation where the computing platform 200 comprises a plurality of physical computing resources connected via a network, the one or more communication interfaces 206 may be configured to facilitate wireless and/or wired communication between those physical computing resources (e.g., between computing and storage clusters in a cloud network). As such, the one or more communication interfaces 206 may take any suitable form for carrying out these functions, examples of which may include an Ethernet interface, a serial bus interface (e.g., Firewire, USB 3.0, etc.), a chipset and antenna adapted to facilitate wireless communication and/or any other interface that provides for wireless communication (e.g., Wi-Fi communication, cellular communication, short-range wireless protocols, etc.) and/or wired communication, among other possibilities. The one or more communication interfaces 206 may also include multiple communication interfaces of different types. Other configurations are possible as well.

Although not shown, the computing platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with the computing platform 200.

It should be understood that the computing platform 200 is one example of a computing platform that may be used with the embodiments described herein. Numerous other arrangements are possible and contemplated herein. For instance, other computing platforms may include additional components not pictured and/or more or less of the pictured components.

Turning now to FIG. 3, a simplified block diagram is provided to illustrate some structural components that may be included in an example end-user device 300, such as an end-user device 112 described above with reference to FIG. 1. As shown in FIG. 3, the end-user device 300 may include one or more processors 302, data storage 304, one or more communication interfaces 306, and one or more user-interface components 308, all of which may be communicatively linked by a communication link 310 that may take the form of a system bus or some other connection mechanism. Each of these components may take various forms.

The one or more processors 302 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 304 may comprise one or more non-transitory computer-readable storage mediums that are collectively configured to store (i) program instructions that are executable by the processor(s) 302 such that the end-user device 300 is configured to perform certain functions related to interacting with and accessing services provided by a computing platform, such as the example computing platform 200 described above with reference to FIG. 2, and (ii) data that may be received, derived, or otherwise stored, for example, in one or more databases, file systems, repositories, or the like, by the end-user device 300, related to interacting with and accessing the services provided by the computing platform. In this respect, the one or more non-transitory computer-readable storage mediums of the data storage 304 may take various forms, examples of which may include volatile storage mediums such as random-access memory, registers, cache, etc., and non-volatile storage mediums such as read-only memory, a hard-disk drive, a solid-state drive, flash memory, an optical-storage device etc. The data storage 304 may take other forms and/or store data in other manners as well.

The one or more communication interfaces 306 may be configured to facilitate wireless and/or wired communication with other computing devices. The one or more communication interfaces 306 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The end-user device 300 may additionally include or have interfaces for one or more user-interface components 308 that facilitate user interaction with the end-user device 300, such as a keyboard, a mouse, a trackpad, a display screen, a touch-sensitive interface, a stylus, a virtual-reality headset, and/or one or more speaker components, among other possibilities.

It should be understood that the end-user device 300 is one example of an end-user device that may be used to interact with a computing platform as described herein. Numerous other arrangements are possible and contemplated herein. For instance, in other embodiments, the end-user device 300 may include additional components not pictured and/or more or fewer of the pictured components.

### III. EXAMPLE OPERATIONS

As mentioned above, Procore Technologies has continued to develop software technology related to construction management and/or workflows associated with construction management. Disclosed herein is new software technology that is generally directed to receiving incongruous rules and incongruous data sets at a computing platform, generating logical flowcharts and/or templates of logical flowcharts for re-use by users of the computing platform, and utilizing the data and flowcharts collected and/or generated via this process to provide for predictive analysis for a construction project.

i. Systems and Methods of Dynamic Generation of Logical Flowcharts Based on Incongruous Rules and/or Data Sets

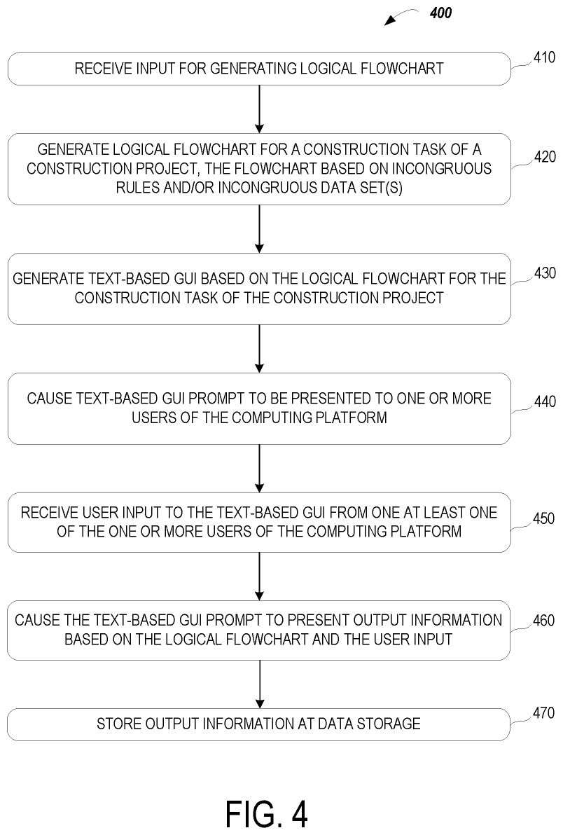

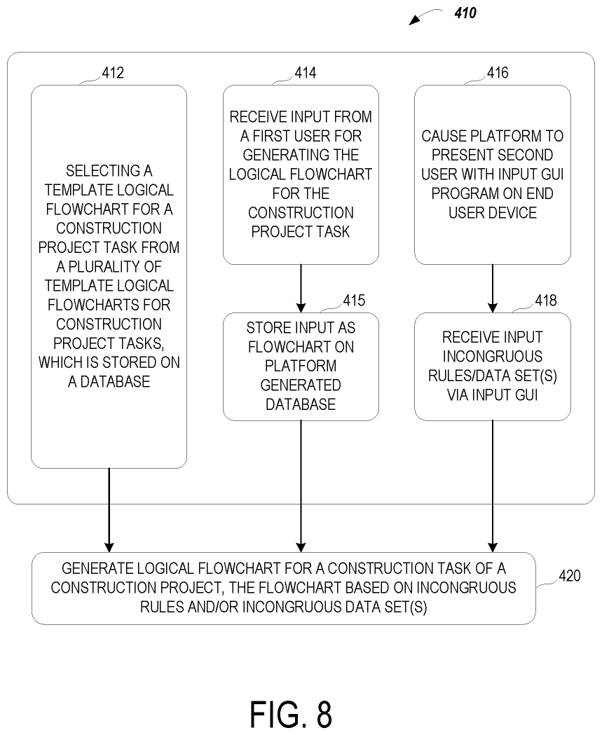

Turning now to FIG. 4, an example flow diagram for a method 400 carried out by one or more of the back-end computing platform 102, 200, the end-user device(s) 300, or combinations thereof. The method may begin at block 410, wherein the computing platform receives input for generating a logical flowchart for use by the computing platform, in a construction-related project or task. Examples for receiving input for generating logical flowcharts may include receiving direct user input via a client station (e.g., an end user device 300), receiving input via selection of a template logical flowchart, receiving input based on prior input from another or second user of the computing platform at a second client station, among other examples of input receipt. Example processes for receiving such input are described in greater detail, below, with respect to FIG. 8.

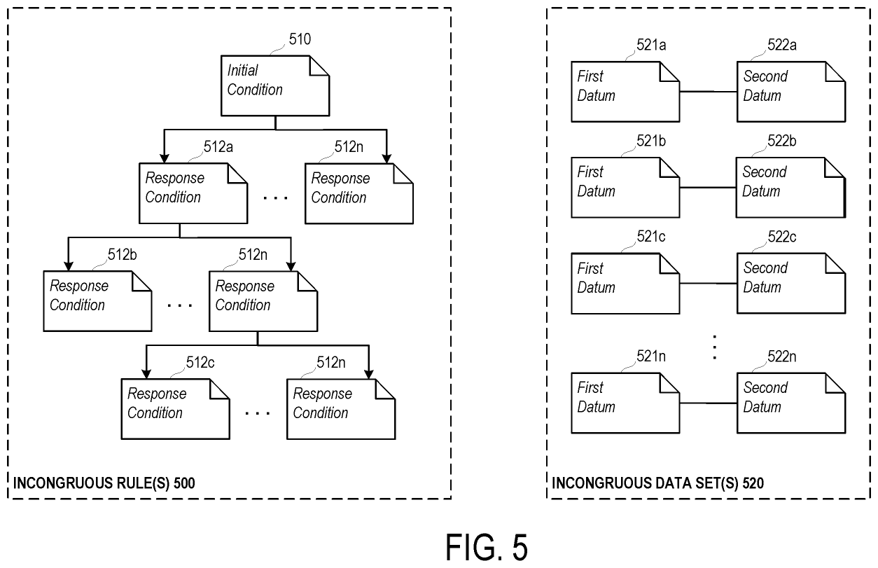

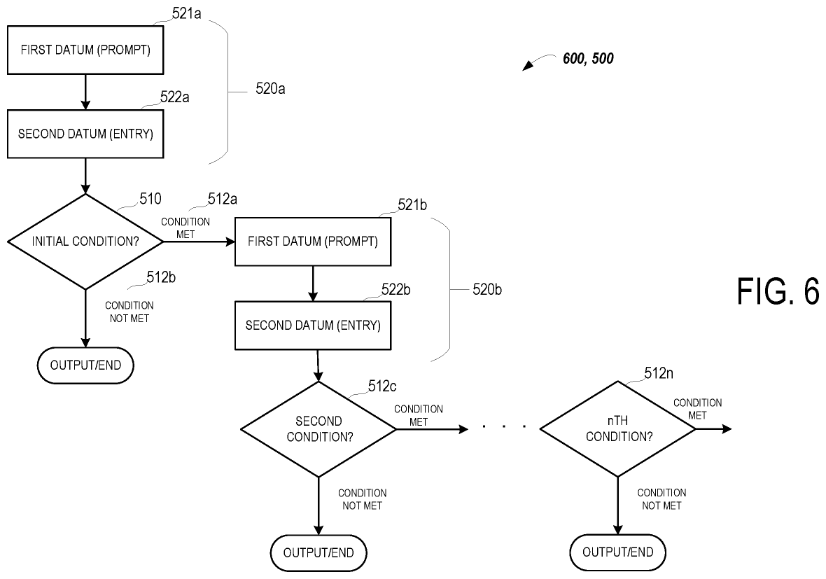

As illustrated at block 420, the method 400 further includes generating a logical flowchart 600 (FIG. 6) for a construction project task based on, at least, incongruous rules 510 and incongruous data sets 520 (FIG. 5).

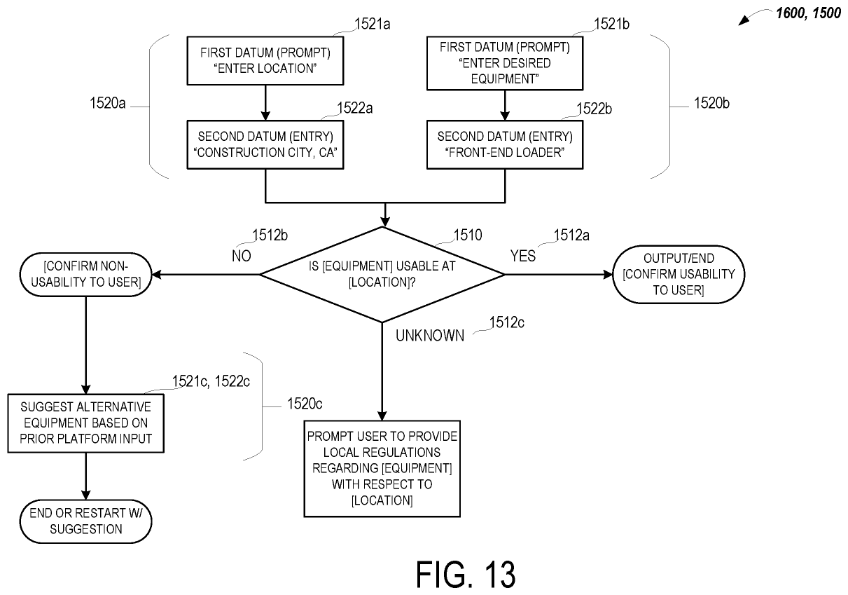

Referring now to FIG. 5 and with continued reference to FIG. 4, a graphic representation of incongruous rules 500 and incongruous data sets 520 is illustrated. Incongruous rules 500 refer to any functions, relationships, or methods for determining data that does not follow concise, easily repeatable rules and that, generally, would require direct user input for each query posed to said rule, absent prior user-input. Thus, easy, user-friendly systems and methods for translating data via incongruous rules are not easily programmed in a way that covers a majority of construction scenarios, absent significant user intervention. As illustrated, incongruous rules 500 include an initial condition 510 and one or more response conditions 512, which may be prompted in a logical flowchart 600 in response to input to the initial condition 510 and/or in response to input to a response condition 512. As illustrated, each of the initial condition and each response condition 512 may have multiple response conditions 512, each responsive to a particular input, up to “n” number of response conditions 512n. Examples of incongruous rules 500 may include, but are not limited to including, regulatory constraints associated with a locality or jurisdiction, environmental constraints associated with a locality or area, local tax codes or business regulations affecting pay in local or hyper-local areas, workflow constraints based on local labor regulations, among other rules or logic that are not easily determined without direct user input. Example conditions 510, 512 will be better understood with reference to the logical flowchart 600 of FIG. 6 and/or the exemplary logical flowcharts of FIGS. 13-15.

Each of the incongruous rules 500 and respective initial condition(s) 510 and respective response condition(s) 512 thereof are one or more of (i) previously received from a first client station associated with a first user, (ii) previously input from the first client station or a second client station, (iii) populated via current user input to the first or second client station, or combinations thereof.

Incongruous data sets 520 refer to any data pairs or data groupings that do not follow a simple, predictable, one-to-one translation, based on fully known or previously stored data (e.g., a LUT, language translation data, etc.). Thus, incongruous data sets rely on direct user input or partial user input, based on a portion of the data set being a prompt to a user. Therefore, easy, user-friendly systems for obtaining or translating data via incongruous data sets are not easily integrated into an application, absent significant user input. Examples of incongruous data sets 520 may include, but are not limited to including, vehicle lists and characteristics thereof, localities and associated restrictions, construction project timing data, user-defined part replacement suggestions, etc. As illustrated, members of a plurality of incongruous data sets 520 may each include a first datum 521 and a second datum 522, wherein the first datum 521 and the second datum 522 may be correlated at the point of user input. While illustrated as data sets 520 having a pair of datum 522, 523, it is certainly possible that each data set 520 be more than a correlated pair and may include any number of incongruous datum.

Each of the incongruous data sets 520 and respective first datum 521 and respective second datum 522 thereof are one or more of (i) previously received from a first client station associated with a first user, (ii) previously input from the first client station or a second client station, (iii) populated via current user input to the first or second client station, or combinations thereof.

Further, each of the at least one incongruous rule(s) 500, the incongruous data set(s) 520, the initial condition(s) 510, the response condition(s) 512, the first datum 521, and the second datum 522 are all associated with a construction project task.

Turning now to FIG. 6 and with continued reference to FIGS. 4 and 5, an example logical flowchart 600, utilizing incongruous rules 500 and incongruous data sets 520 is illustrated. The logical flowchart 600 begins with a first datum 521a of a first incongruous data set 520a, which may be a prompt presented to a user, for the purpose of instructing the user to input data for the second datum 522a of the first incongruous data set 520a. Thus, the prompt of the first datum 521a will then be correlated with the input data for the second datum 522a. In one example, the first datum 521a may be a prompt instructing a user to input a location for the construction project and the second datum 522a may be populated by the user input data associated with the location for the construction project.

Upon receipt of the second datum 522a, in the example logical flowchart 600, the first incongruous data set 520a may be utilized by the initial condition 510 of incongruous rules 500 for the logical flowchart 600. First and second response conditions 512a, 512b may be whether or not the initial condition 510 is met. In some examples, such as the illustrated example of FIG. 6, if the initial condition 510 is not met, then output information is given to the user, via the client station, and the logical flowchart 600 ends. However, as illustrated, if the first condition is met, then the logical flowchart 600 may continue to prompt a user for input for a second incongruous data set 520b, which then may be analyzed via a third response condition 512c. Further, any number of incongruous data sets 520, up to “n” number of incongruous data sets 520n, may be utilized and/or collected via the logical flowchart 600 and processed or evaluated via any number of additional response conditions, up to “n” number of response conditions 512n.

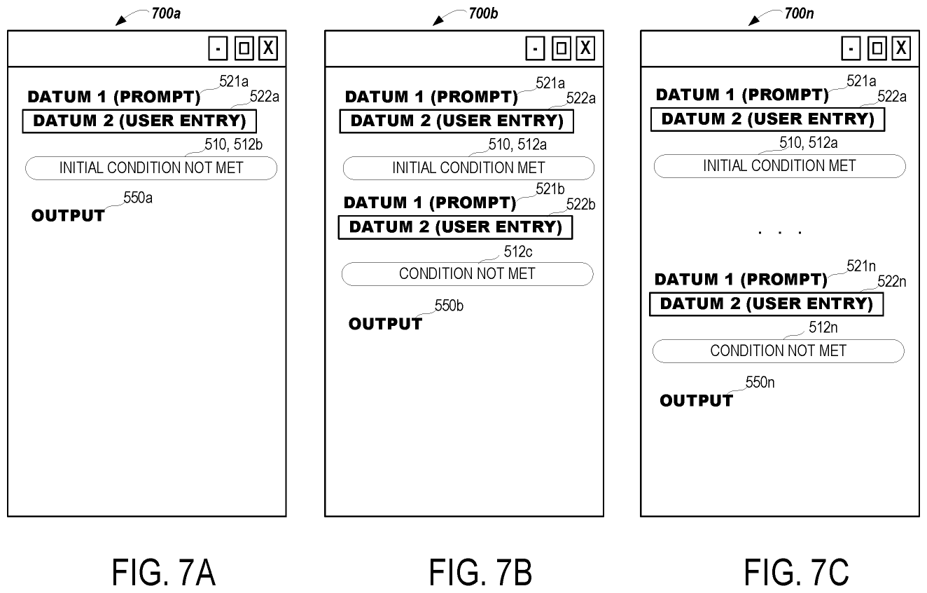

Returning now to the method 400 of FIG. 4, after the logical flowchart 600 is generated at block 420, the logical flowchart 600 is then utilized by the computing platform 102, 200 to generate a text-based GUI prompt 700 (FIG. 7) based on the logical flowchart 600 (block 430, FIG. 6), and cause the text-based GUI prompt 700 to be presented to a user of the computing platform 102, 200, via one or more of the first client station, the second client station, or combinations thereof (block 440). Then, the computing platform 102, 200 will receive, from the first client station or the second client station, an indication of user input to the text based GUI prompt 700, as illustrated in block 450. Upon receipt of at least one input from a user, the method 400 will then continue to block 460, wherein the computing platform 102, 200 will cause the text-based GUI prompt 700 to present output information to the user, via a client station, based on the logical flowchart 600 and the user input. Then, in some examples, the method 400 includes storing, at least, the output information on at least one non-transitory computer readable medium of the computing platform 102, 200.

As illustrated in FIGS. 7, the text-based GUI prompt 700 will prompt a user of a client device (end-user device 300) with a text-based prompt for inputting data, which may be utilized as part of incongruous data sets 520 and/or may be utilized as parts of incongruous rules 500. For example, FIG. 7A illustrates a first instance of a text-based GUI prompt 700a, based on the logical flowchart 600 of FIG. 6. In the text-based GUI prompt 700a of FIG. 7A, the first datum 521a is presented to the user as a prompt, wherein the user then inputs the second datum 522a, via the text-based GUI prompt 700a. In this example, the initial condition 510 is not met, and thus the response condition 512b is triggered, which results in the text-based GUI prompt 700a providing output information 550a, based on, at least, the user input to the text-based GUI prompt 700a and the logical flowchart 600.

In an alternative scenario, but utilizing the same logical flowchart 600, an example text-based GUI prompt 700b is illustrated in FIG. 7B. In this example, the first datum 521a is presented to the user as a prompt, wherein the user then inputs the second datum 522a, via the text-based GUI prompt 700b. In this example, the initial condition 510 is met and, thus the second incongruous data set 520b is introduced, wherein the first datum 521b is presented to the user as a prompt and the user then inputs the second datum 522b, via the text-based GUI prompt 700b. In this scenario, a third response condition 512c is not met and, thus, the output information 550b is generated and presented via the text-based GUI prompt 700b.

Further, FIG. 7C illustrates the expansive nature of logical flowchart 700n, wherein the logical flowchart 600 may include any number of incongruous rules 510, having “n” number of response conditions 512, up to response condition 520n. Similarly, the logical flowchart 600 may include any number of incongruous data sets 520, up to “n” number of incongruous data sets 520n.

Referring now to FIG. 8 and with continued reference to FIG. 4, particularly blocks 410, 420, an example flow diagram illustrating a plurality of processes for receiving input for generating the logical flowchart 600 is shown. First, at block 412, the input step of block 410 may include selecting a template logical flowchart for a construction project task from a plurality of template logical flowcharts. Such a plurality of template logical flowcharts may be stored on a platform database 650 of the data storage 204. In some examples, one or more of the plurality of logical flowcharts were previously generated by back-end or platform-side users of the computing platform 102, 200. In some additional or alternative examples, one or more of the plurality of logical flowcharts were previously generated by front-end or customer-side users of the computing platform 102.

In some examples of block 410, which is the step of receiving input for generating the logical flowchart 600, the process of 410 may include, at block 414, receiving input from a first user (e.g. a back end or platform-side user) for generating the logical flowchart 600 for the construction task. In such methods, the computing system 102 may further be configured to store the input from block 414 on a platform database of the platform storage 204, as illustrated in block 415. Thus, platform-side users of the computing platform are able to input logical flowcharts 600, which then may be subsequently used by the same platform-side user or another platform-side user to simplify or automate some development tasks, for generating logic-based applications or features, which utilize or require incongruous rules and/or datasets.

Further, in some examples of the process of block 410, the process includes causing the computing platform 102 to present a front-end or customer-side user of the computing platform 102 with an input GUI for the user to provide input for generating the logical flowchart 600. In such an example, a program (such as a workflow generation program) may provide a customer-side user with pre-formed or customizable logic blocks and data inputs and allow the customer-side user to arrange and edit ordering of the blocks of the flowchart 600, to customize the flowchart 600 to the customer-side user's specific needs. In such examples, as illustrated in block 418, the computing platform receives said input of incongruous rules and data sets via the input GUI and generates the flowchart 600 therefrom. In some such examples, the process of block 410 may include storing the input information and/or the resultant logical flowchart 600 on the platform database 925, for future use by either platform-side or customer-side users of the computing platform 102.

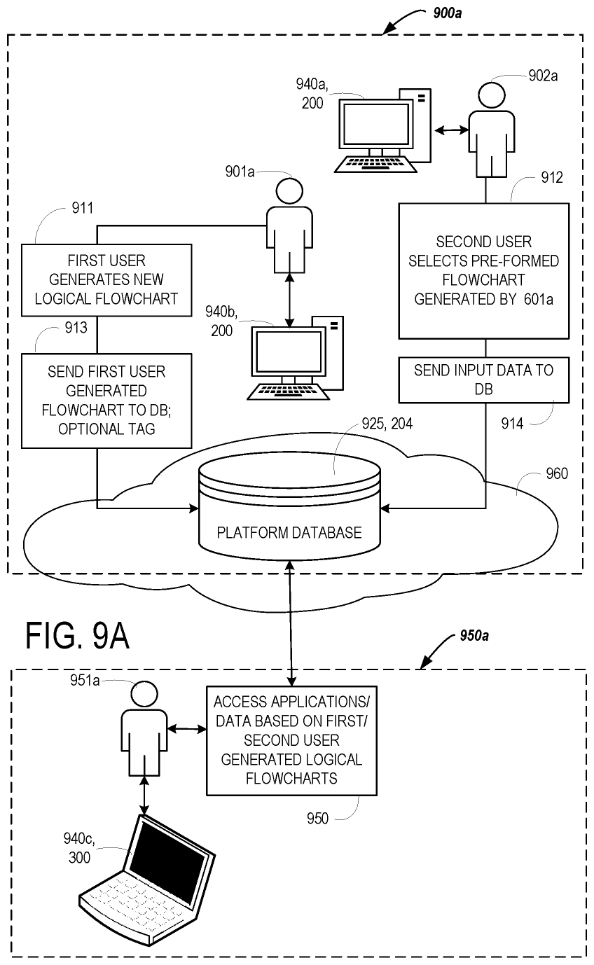

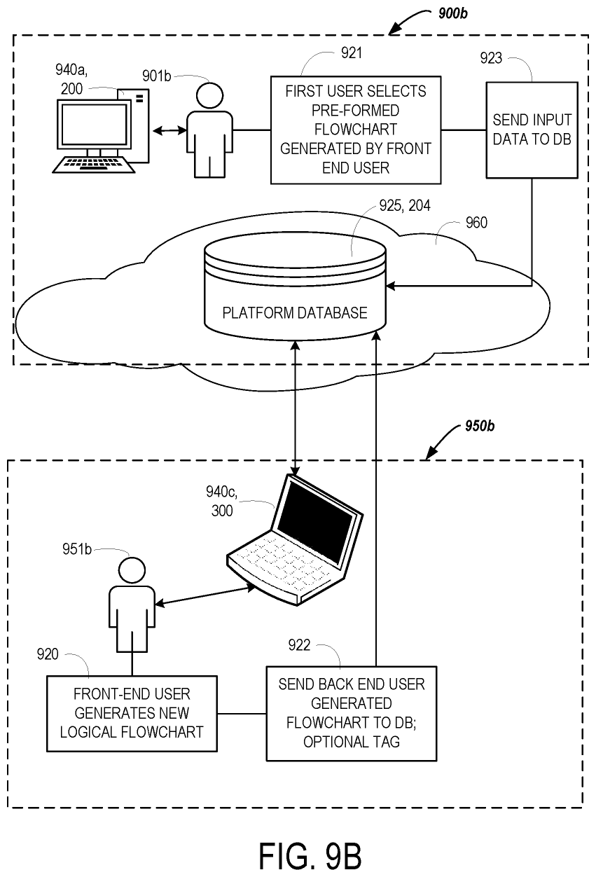

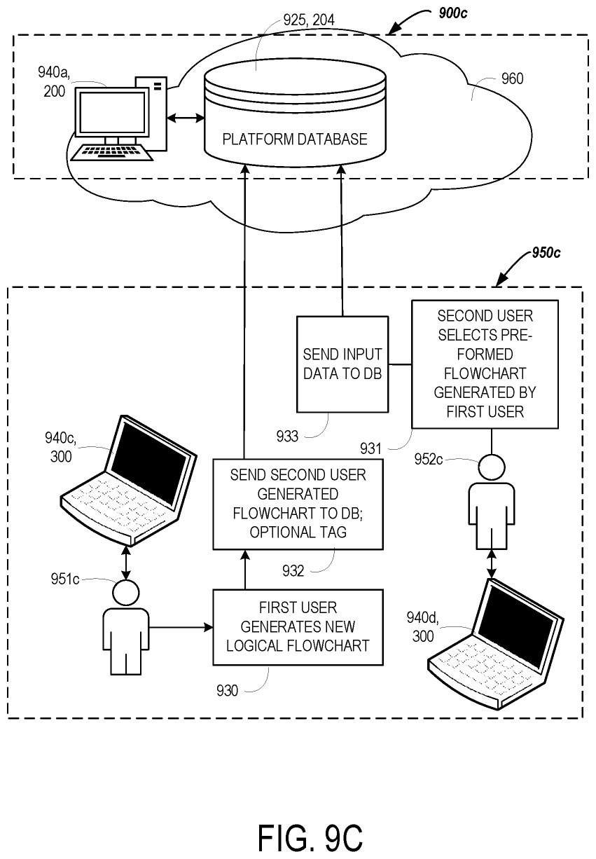

Turning now to FIG. 9A and with continued reference to FIGS. 1-8, a first diagram for a computing environment associated with the computing system 102, exemplifying a first user configuration, is illustrated. The computing environment is a combination of a first platform-side environment 900a and a first customer-side environment 950a. The first platform-side environment 900a shows first and second platform-side users 901a, 902a, the respective client stations 940a, 940b used by or otherwise associated with the first and second platform-side users 901a, 902a, respectively, the platform database 925, and a plurality of blocks 911, 912, 913, 914, which are included to illustrate actions taken by the users 901a, 902a within the first user configuration and scenario of FIG. 9A. Further, the first customer-side environment 900a shows a customer-side user 951a, the client station 940c associated with the customer-side user 901, and block 910, which is included to illustrate action taken by the user 951a. Each of the client stations 940 and the platform database 925 are connected to one another via the Internet 960. In the example of FIG. 9A, the first platform side user 901a generates a new logical flowchart 600 (block 911) and the logical flowchart 600 generated is stored on the platform database 925, with, optionally, a tag identifying a type of construction project associated with the logical flowchart 600. The second platform side user 902a can then select the previously formed logical flowchart 600 of block 911 for use in generating a logical flowchart for a task or program developed by the second platform side user 902a (block 912). Then, the input data to the flowchart used by the second platform-side user 902a may be sent to the platform database 925.

FIG. 9B is a second diagram for a computing environment associated with the computing system 102, exemplifying a second user configuration. The computing environment is a combination of a second platform-side environment 900b and a second customer-side environment 900b. The second platform-side environment 900b shows a first platform-side user 901b, the associated client station 940a used by or otherwise associated with the first platform-side user 901b, and the platform database 925. Blocks 921, 923 are included to illustrate actions taken by the user 901b within the second user configuration and scenario of FIG. 9B. Further, the second customer-side environment 900b shows a customer-side user 951b, the client station 940c associated with the customer-side user 951b, and blocks 920, 922, which are included to illustrate action taken by the user 951b. Each of the client stations 940 and the platform database 925 are connected to one another via the Internet 960. In the example of FIG. 9B, the customer-side user 951b generates a new logical flowchart 600 via, for example, a GUI of the computing platform 102 for generating logical flowcharts, as illustrated by block 920. Then, the generated logical flowchart 600 is sent to and stored on the platform database 925, where it may be utilized for future use by one or more platform-side or customer-side users of the computing platform 102. Then, as illustrated in block 921, the platform side user 951b may utilize the pre-formed logical flowchart, generated by the customer-side user 951b, for use in application development on the platform-side environment 950b. Then, input data to the selected logical flowchart may be stored on the platform database 925.

FIG. 9C is a third diagram for a computing environment associated with the computing system 102, exemplifying a third user configuration. The computing environment is a combination of a third platform-side environment 900c and a third customer-side environment 950c. The third platform-side environment 900c shows the platform database 925 and a client station 940a associated with the platform database 925. Further, the third customer-side environment 950c shows a first customer-side user 951c, a second customer-side user 952c, the respective client stations 940c, 940d used by or otherwise associated with the first and second customer-side users 951c. 952c, and blocks 930, 931, 932, 933, which are included to illustrate action taken by the users 951c, 952c. Each of the client stations 940 and the platform database 925 are connected to one another via the Internet 960. In the example of FIG. 9C, the first customer side user 951c generates a new logical flowchart 600, as illustrated by block 930. Then, the logical flowchart 600 is sent to the platform database 925 with an optional tag, the optional tag associating the generated logical flowchart 600 with at least one construction task (block 932). Then the second customer side user 952c selects the pre-formed logical flowchart 600, generated at block 930, for use in an application of the computing platform such as, but not limited to, a workflow generation program. Then, input data, input to the logical flowchart 600 by the second customer side user 952c is sent to the platform database 925.

ii. Utilizing Incongruous Rules and Data Sets in Workflow Applications and Machine Learning Models for Predicting Input to Workflow Applications

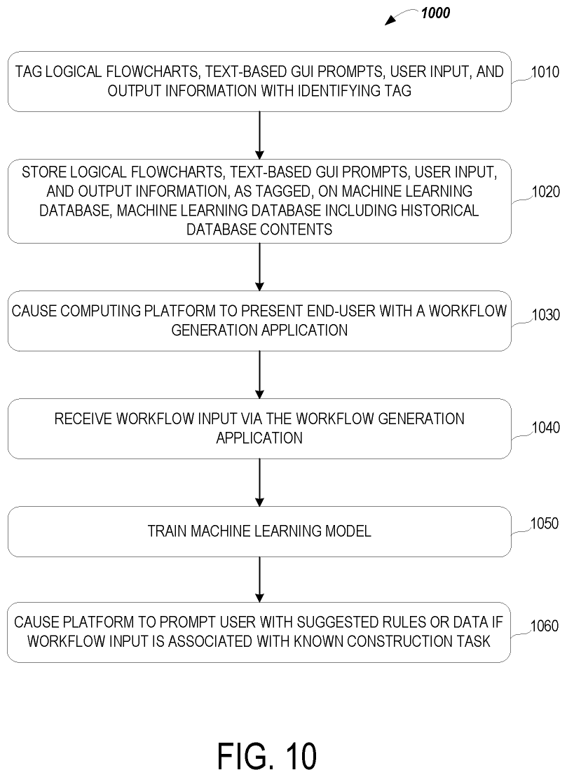

In some example embodiments, particularly those utilizing the method 400 as part of a workflow generation application or process, the logical flowcharts, incongruous rules and/or data, and/or input to the aforementioned may be utilized in predictive workflow generation. To that end, FIG. 10 is a flow diagram for a method 1000 for utilizing logical flowcharts for gathering information, processing said information, and utilizing the information in generating workflows via a workflow application. One or more of the steps illustrated in the flow diagram, for the method 1000, of FIG. 10 may be utilized with or in conjunction with the method 400, for the purpose of workflow generation and/or workflow optimization.

Prior to launching a workflow generation application, the method 1000 may optionally include blocks 1010, 1020, wherein, at block 1010 logical flowcharts 600, text-based GUI prompts 700, user input thereof, output information 550, and combinations thereof, may be tagged with an indicator associated with a construction task or a construction task type. Such tagging may be performed affirmatively by a user (e.g., a platform-side user specifically classifying a logical flowchart as associated with a specific type of construction task). Additionally or alternatively, the logical flowcharts and/or associated data may be procedurally tagged by the computing platform 102, wherein the data is processed and software of the computing platform determines a tag for each data object. Further, as illustrated in block 1020, the logical flowcharts 600, text-based GUI prompts 700, user input, output information 550, among other data, may be stored on a machine learning data base of or associated with the platform database 925 and/or the data storage 204.

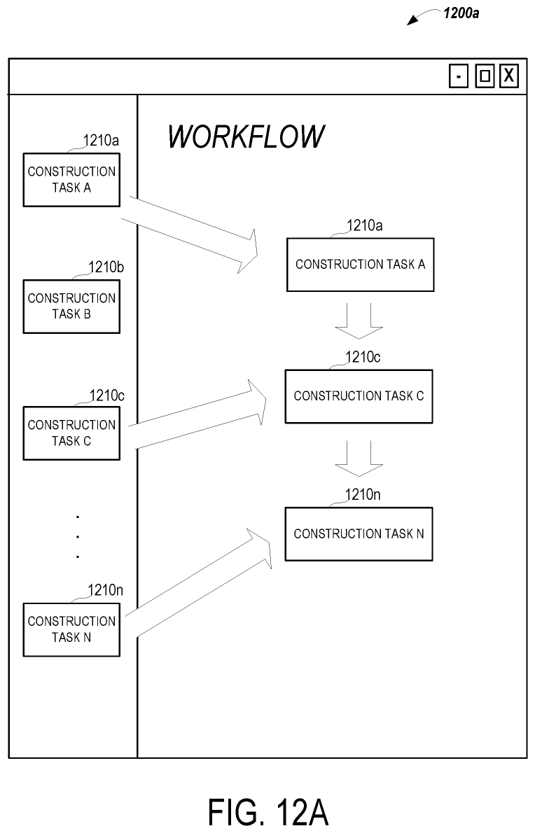

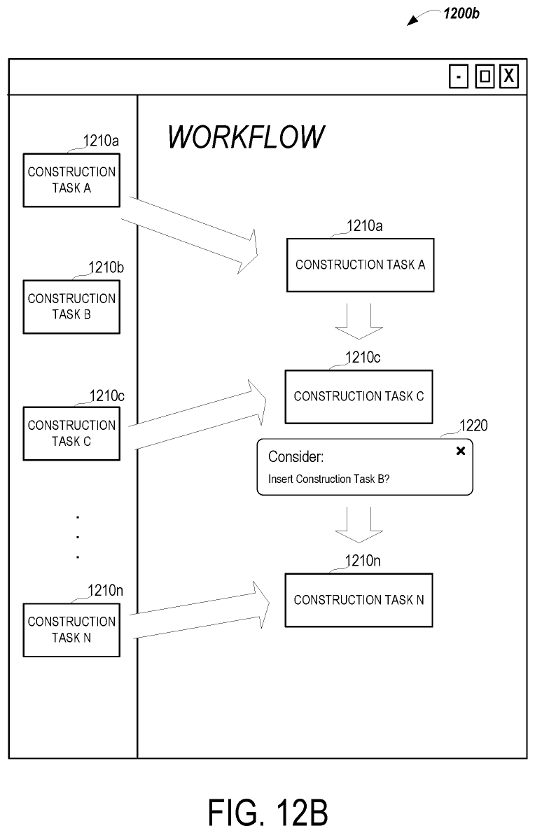

At block 1030, operations associated with workflow generation begin, wherein the computing platform 102, 200 causes a client station to present a customer-side user with a workflow generation application. An example GUI interface 1200a for the workflow generation application is illustrated in FIG. 12A, wherein, on the left side, a number of construction tasks 1210A-N are presented to a user, via a client station, and a user can select tasks and input relevant information associated with the workflow and/or associated task, via the workflow generation application. As illustrated, the user may select one or more of the construction tasks 1210 and order them as a workflow.

Returning now to FIG. 10, and with continued reference to FIG. 12A, at block 1040, the method 1000 includes receiving, via the workflow generation application, workflow input. For example, the described selection and ordering of construction tasks 1210 is an example of workflow input. One or more of the construction tasks 1210 and/or features thereof may be based on one or more of a logical flowchart 600 or a text-based GUI prompt 700.

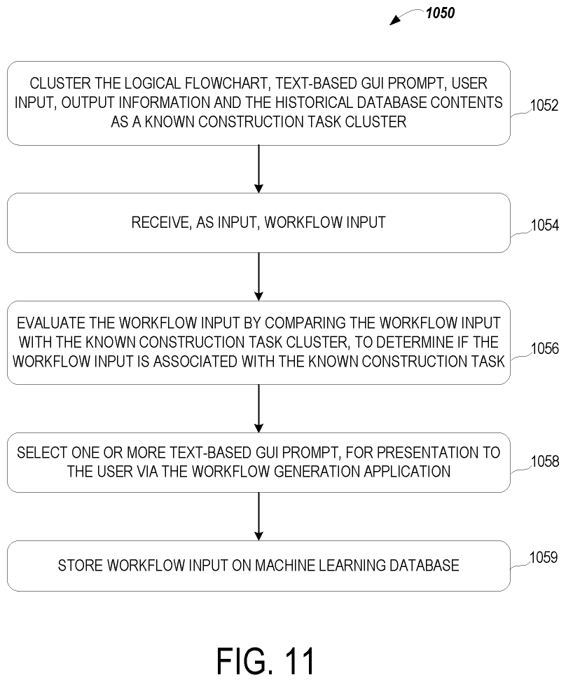

At block 1050, the method 1000 includes training a machine learning model for predictive workflow operations. To that end, FIG. 11 is a flow diagram for the step of training and/or otherwise utilizing the machine-learning model for predictive workflow generation. Prior to executing steps of the process of block 1050, the method 1000 may have tagged each of the logical flowcharts 600, the text-based GUI prompts 700, the user input, and the output information 550 with an identifying tag associated with a known construction task (block 1010).

Further still, prior to executing the steps of the process of block 1050, the method 1000 may have stored each of the logical flowcharts 600, the text-based GUI prompts 700, the user input, and the output information 550, as tagged with the identifying tag associated with the known construction task, on a machine-learning database. The machine learning database has, stored thereon, historical database contents associated with the known construction task. The historical database contents include one or more of historical logical flowcharts associated with the known construction task, historical text-based GUI prompts associated with the known construction task, historical user input associated with the known construction task, and historical output information associated with the known construction task, or combinations thereof.

Beginning at block 1052, the method 1050 beings to train the machine-learning model by carrying out a machine learning process on a training data set that includes the aforementioned input storage of block 1020 along with the historical database contents. At block 1052, the machine-learning model is trained by clustering the logical flowcharts 600, the text-based GUI prompts 700, the user input, the output information 550, and the historical data base contents, all tagged with a common known construction task, as a known construction task cluster.

To that end, the computing platform 102 may apply a clustering technique (or sometimes referred to as a cluster analysis), such as a k-means clustering technique, that clusters the sets of new input data and historical data entities based on one or more features included or associated with the sets of historical data entities, such that the sets of historical data entities in each respective cluster have similar features to one another. For example, some sets of historical data entities may have been clustered together in one cluster based at least in part on the sets of historical data entities comprising historical data entities that identify a similar physical construction project size (e.g., a similar square footage). As another example, some sets of historical data entities may have been clustered together in one cluster based at least in part on the sets of historical data entities comprising historical data entities that identify a similar construction project type (e.g., new build versus renovation). As yet another example, some sets of historical data entities may have been clustered together in one cluster based at least in part on the sets of historical data entities comprising historical data entities that identify similar keywords in a construction project description (e.g., “school,” “condominium,” “gymnasium,” etc.). Sets of historical data entities may be clustered together based on combinations of these and other similar characteristics as well.

By clustering the sets of historical data entities in this way, the computing platform 102 may thereby produce clusters of past construction projects having similar sets of historical data entities. As noted above, each set of historical data entities corresponds to a different respective past construction project. As such, when clustering the sets of historical data entities based on their similarities, the computing platform 102, 200 is effectively clustering the past construction projects based on the past construction projects having similar sets of historical data entities.

Returning now to FIG. 11, process 850 includes receiving the workflow input (e.g., the workflow input discussed above with respect to block 1040 of FIG. 12). Then, the method 1050 includes evaluating the workflow input by comparing the workflow input with the known construction task cluster, to determine if the workflow input is associated with the known construction task, as illustrated in block 1056. In addition to evaluating the workflow input versus the construction task cluster, in some examples of evaluating the workflow input, the computing platform 102 may optionally pre-process the data included within the set of previously-created historical data entities so as to increase the suitability of the data and/or determine one or more features of the data for use as training data for the machine-learning model. As one example, pre-processing may take the form of Natural Language Processing (“NLP”) techniques that analyze user-inputted data in a way that enables the back-end platform to better “understand” the overall context of the data. Such NLP techniques may include, as some nonlimiting examples, identifying and extracting keywords and/or key features from the raw text included in user-input data, correcting any spelling and/or grammatical errors, unification, non-ASCII character removal, stop word removal, lemmatization, and sentiment analysis.

Further, at block 1058, if the evaluation of block 1056 determines that the workflow input is associated with the known construction task, then the computing platform 102 will select one or more of the text-based GUI prompt, one or more historic text based GUI prompts, a machine-generated text based GUI prompt, or combinations thereof, for presentation to the user via the workflow generation application. Further, if the evaluation of block 1056 determines that the workflow input is associated with the known construction task, then the workflow input is stored on the machine-learning database, as illustrated in block 1059.

Returning now to FIG. 10 and block 1060 thereof, the method includes, if the machine-learning model determines that the workflow input is associated with the known construction task, causing the computing platform 102 to prompt the user with one or more of a suggested incongruous rule, a suggested incongruous data set, a suggested logical flowchart, a suggested text-based GUI prompt, or combinations thereof.

For visual understanding of the method(s) of FIGS. 10 and 11, FIG. 12B illustrates an example GUI 1200b of the workflow generation application, utilizing the machine-learning model of method 1250 to produce predictive suggestions 1220 for presentation to a user of a client station. As illustrated with like elements and reference numbers to those of the GUI 1200a of FIG. 11A, the workflow generation application has user input, via the placement of construction tasks 1210a, 1210c, . . . , 1210n as an ordered workflow. The computing platform may evaluate this user input to the workflow generation application, using the machine-learning model, and determine that the input steps of the workflow input indicate that this workflow is intended for a known construction task that has an associated known construction task cluster on the machine learning database. Then, said evaluation may determine that, for example, in similar instances of workflows associated with this known construction task, the workflow normally includes construction task 1210b, in between construction task 1210c and construction task 1210n. Thus, based on the evaluation of the workflow input, versus the clusters of the machine learning model, the computing platform may generate the predictive suggestion 1220, wherein the workflow application prompts the user with a suggestion to insert construction task 1210 between construction task 1210c and 1210n.

iii. Example Logical Flowcharts and Associated Text-Based GUIs, Based on Construction-Related Incongruous Rules and/or Data Sets

Referring now to FIGS. 13-15, example logical flowcharts 1600, 2600, 3600 are illustrated to show practical use of the systems and methods herein, within the context of construction management and/or execution of construction projects and/or tasks thereof. Said logical flowcharts can be converted for use as text-based GUI prompts (e.g., similar to the GUI prompts of FIG. 7) for use within, for example, a workflow generation application.

Referring first to FIG. 13, a first example construction-based logical flowchart 1600 is illustrated. The logical flowchart 1600 relies on incongruous data sets 1520a, 1520b, 1520c and incongruous rules 1500. In the example of FIG. 13, the logical flowchart 1600 is for determining if a vehicle associated with a construction project and/or a construction project task thereof is suitable for that project, based on the location at which the project is to commence. For example, a construction machine may be too large to reach a certain construction site due to, for example, narrow roads leading to the site, narrow or weak bridges constraining the cite, local emissions and/or weight of vehicle requirements, legality of the machine within a certain jurisdiction, among other potential restrictions and/or regulations that may prevent vehicle use at a construction site.

As illustrated, the logical flowchart 1600 includes a first incongruous data set 1520a, which is a prompt (first datum 1521a) for inputting a location and the second datum 1522a is populated by a user input for the location of the construction site for the associated task. The location may be as global as a jurisdiction or country, may be as hyper local as a street address, or may be any other location of any scope or scale. A second incongruous data set 1520b may also be a prompt (first datum 1521b) for a user to input a vehicle for use at the location, the vehicle information being the second datum 1522b. Then, based on the user input to the data 1522a, 1522b, the logical flowchart 1600 will utilize the initial condition 1510 to determine if the vehicle is available for use at the given location. This evaluation of the initial condition 1510 may be performed via user input telling the flowchart which vehicles are available at what locations or the computing system 102, 200 may query a database of information of previously consumed incongruous, vehicle rules and data sets to determine the outcome. If, via the first response condition 1512a, it is determined that the vehicle is usable, then the output will be to confirm usability to the user. However, if the response condition is the second response condition 1512b, then non-usability will be confirmed to the user and, optionally, a third incongruous data set may be presented that provides an alternative, usable vehicle (second datum 1522c) for use at the location (first datum 1521c). Lastly, if it is unknown whether the vehicle is usable at the location (response condition 1512c), then the user will be prompted to provide local regulations regarding the specified equipment, if known by the user.

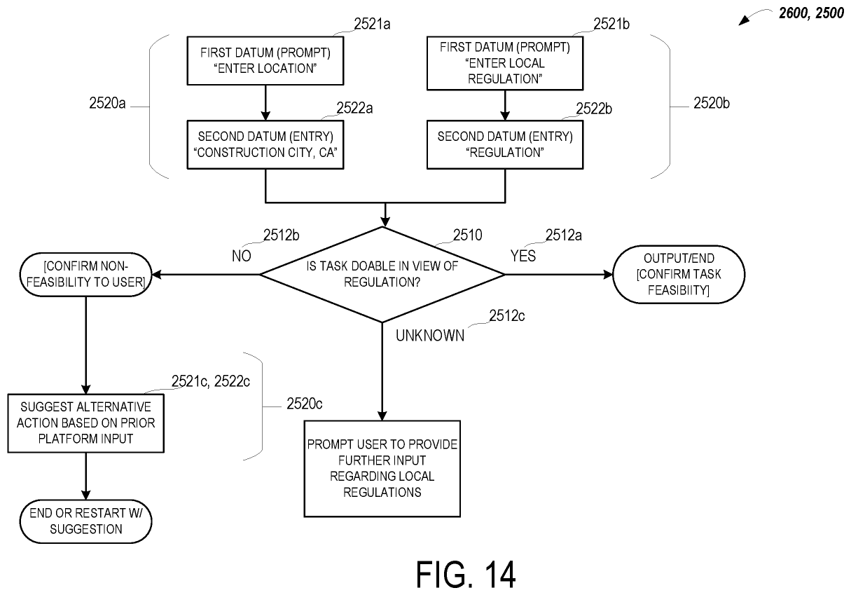

Turning now to FIG. 14, a second example construction-based logical flowchart 2600 is illustrated. The logical flowchart 2600 relies on incongruous data sets 2520a, 2520b, 2520c and incongruous rules 2500. In the example of FIG. 14, the logical flowchart 2600 is for determining if a construction project or task associated with a construction project is able to be performed at a specific location, based on the location at which the project is to commence. For example, regulations that may restrict construction activity, as specific to a particular location, include, but are not limited to, noise ordinances that may limit machine use, building code restrictions within a jurisdiction, land use requirements, affordable housing requirements, existence of municipal casements or other permissions, among other potential restrictions and/or regulations that may prevent a task from being performed at a construction site.

As illustrated, the logical flowchart 2600 includes a first incongruous data set 2520a, which is a prompt (first datum 2521a) for inputting a location and the second datum 2522a is populated by a user input for the location of the construction site for the associated task. The location may be as global as a jurisdiction or country, may be as hyper local as a street address, or may be any other location of any scope or scale. A second incongruous data set 2520b may also be a prompt (first datum 2521b) for a user to input a known regulation or municipal rule, applicable at the location, said regulatory information being the second datum 2522b. Then, based on the user input to the datums 2522a, 2522b, the logical flowchart will utilize the initial condition 2510 to determine if the task can be performed at the location. This evaluation of the initial condition 2510 may be performed via user input telling the flowchart which tasks are (or are not) performable at what locations or the computing system 102, 200 may query a database of information of previously consumed incongruous, regulatory rules and data sets to determine the outcome. If, via the first response condition 2512a, it is determined that the task can be performed, then the output will be to confirm usability to the user. However, if the response condition is the second response condition 2512b, then non-performability will be confirmed to the user and, optionally, a third incongruous data set may be presented that provides an alternative, performable task within the regulatory constraints (second datum 2522c) for construction action at the location (first datum 2521c). Lastly, if it is unknown whether the task can be performed at the location (response condition 2512c), then the user will be prompted to provide local regulations regarding the specified construction task.

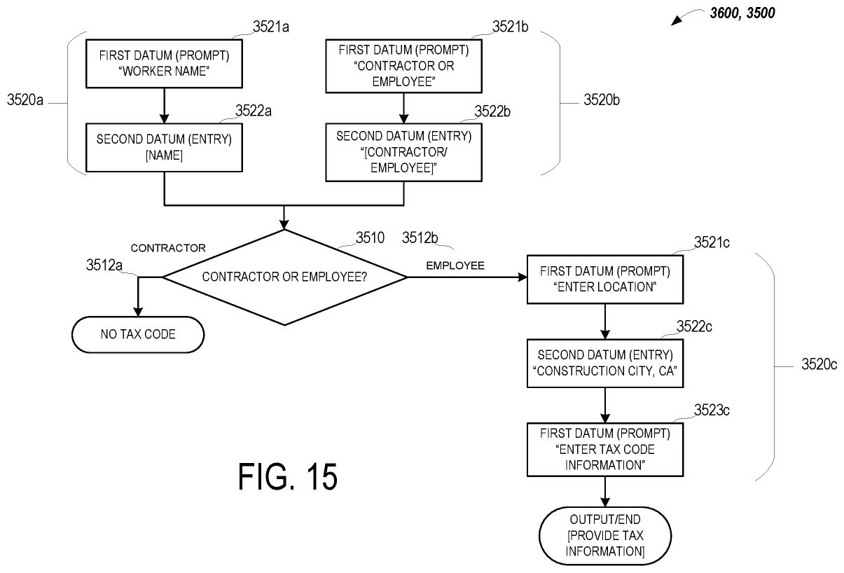

FIG. 15 is a third example construction-based logical flowchart 3600. The logical flowchart 3600 relies on incongruous data sets 3520a, 3520b, 3520c and incongruous rules 3500. In the example of FIG. 15, the logical flowchart 3600 is for determining if a given worker on a construction task or project is a contractor or employee and, if an employee, what tax codes are relevant to his/her/their pay, based on the locality.

As illustrated, the logical flowchart 3530 includes a first incongruous data set 3520a, which is a first prompt (first datum 3521a) for inputting an employee's name then said name input is the second datum 3522a. A second incongruous data set is populated via a prompt (first datum 3521b) to query whether the worker of the first incongruous data set 3520a is an employee of a builder of the construction task or a contractor for the construction task. At the initial condition, if the worker is a contractor, then the first response condition 3512a is triggered and no tax information is necessary, as the employer may not need to pay or withhold taxes for the contractor. However, if the second response condition 3512b is triggered, then tax codes must be considered and the logical flowchart proceeds to gathering incongruous data for a third incongruous data set 350c

The third incongruous data set 3520c is populated by via a prompt (first datum 35121c) for a user input for the location (second datum 3522c) of the construction site for the associated task and any known tax codes associated with the location (third datum 3523c). The location may be as global as a jurisdiction or country or may be as local as a municipality that imposes an income tax on residents or workers therein. If the tax codes at a certain locality are unknown, the computing platform may query the platform database 650 for tax information to aid in completing data entry for the logical flowchart.

The examples of FIGS. 13-15 only scratch the surface of the usability of the systems and methods disclosed herein for utilizing dynamic generation of logical flowcharts to optimize construction tasks and workflows associated with said construction tasks. These improvements may establish wide ranging databases of incongruous rules and data that are reusable platform-wide by hundreds of thousands, if not millions of users—simplifying workflows by intelligently processing and optimizing data associated with construction projects.

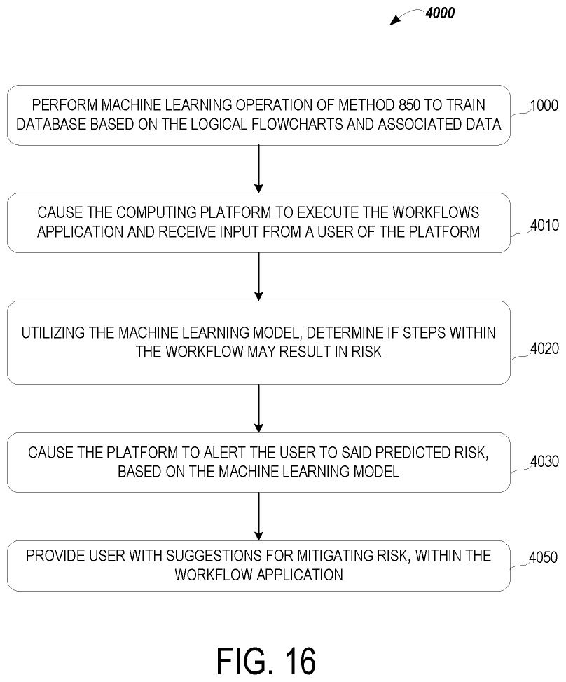

In another example method, which may be performed based on the data gathered and discussed above with respect to FIGS. 4-15, a flowchart for a method 4000 of mitigating risk, based on incongruous data input to a construction management platform, is illustrated in FIG. 16. The method 4000 may begin by executing the method 1050 for performing machine learning operations discussed above, with respect to FIGS. 10 and 11. In such an example, the method 4000 may include block 4010, wherein the aforementioned workflows application is executed and receives input from a user of the computing platform 200, via a client station associated with the user. Utilizing the machine-learning model, the computing platform may determine if the steps in a workflow and/or the ordering thereof may result in risk, by comparing the steps to previously known steps-in-order and evaluating any undesirable outcomes of the steps in that order, as illustrated in block 4020. If it is determined that unnecessary risk exists in the workflow, the method 4000 includes block 4030, wherein the computing system 204 causes the client station to alert the user to said predicted risk. In some examples, then, the method 4000 includes providing the user, via the client station, with suggestions for mitigating risk, within the workflow application, as illustrated in block 4040.

### IV. CONCLUSION

Example embodiments of the disclosed innovations have been described above. Those skilled in the art will understand, however, that changes and modifications may be made to the embodiments described without departing from the true scope and spirit of the present invention, which will be defined by the claims.

For instance, those in the art will understand that the disclosed operations for training and utilizing machine-learning models in the manner described herein to gather, present, and store incongruous rules and data sets, for the purposes of flowchart or workflow generation, may not be limited to only construction projects. Rather, the disclosed operations could be used in other contexts in connection with other types of projects as well.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
at least one network interface;
at least one processor;
at least one non-transitory computer-readable medium; and
program instructions stored on the at least one non-transitory computer-readable medium that are executable by the at least one processor such that the computing platform is configured to:
generate a logical flowchart for a construction project task, the logical flowchart based on at least one incongruous rule and at least one incongruous data set, each incongruous rule comprising a respective initial condition and one or more respective response conditions, each of the respective initial condition and the one or more respective response conditions being one of previously received from a first client station associated with a first user, being previously input from the first client station or a second client station, being populated via current user input to the second client station, or combinations thereof, the at least one incongruous data set including one or more first datum and one or more second datum, each of the one or more first datum correlated with one of the one or more second datum, each of the one or more first datum, the one or more second datum, and correlations thereof being one of previously received from a first client station associated with a first user, being previously input from the first client station or a second client station, being populated via current user input to the second client station, or combinations thereof, each of the at least one incongruous rule, the at least one incongruous data set, the initial condition, the one or more response conditions, the one or more first datum, and the one or more second datum being associated with the construction project task,
generate a text-based graphical user interface (GUI) prompt based on the logical flowchart,
cause the text-based GUI prompt to be presented via one or more of the first client station, the second client station, or combinations thereof,
receive, from the first client station or the second client station, an indication of user input to the text-based GUI prompt,
cause the text-based GUI prompt to present output information, via the first client station, based on the logical flowchart and the user input, and
store, at least, the output information on at least one non-transitory computer readable medium of the computing platform.

2. The computing platform of claim 1, further comprising program instructions stored on the at least one non-transitory computer-readable medium that are executable by the at least one processor such that the computing platform is configured to select a template logical flowchart from a plurality of template logical flowcharts, and
wherein the program instructions that are executable by the at least one processor such that the computing platform is configured to generate the logical flowchart for the construction project task are based on the template logical flowchart.

3. The computing platform of claim 1, wherein the first user of the first client station is a first platform-side user,
wherein the program instructions that are executable by the at least one processor such that the computing platform is configured to generate the logical flowchart for the construction project task are based on platform-side input, and
the computing platform further comprising program instructions stored on the at least one non-transitory computer-readable medium that are executable by the at least one processor such that the computing platform is configured to receive the platform-side input from the first client station.

4. The computing platform of claim 3, wherein the second user of the second client station is a second platform-side user, and
the computing platform further comprising program instructions stored on the at least one non-transitory computer-readable medium that are executable by the at least one processor such that the computing platform is configured to:
store the logical flowchart on a platform generated flowchart database of the computing platform, and
utilizing, by the second platform-side user using the second client station, the logical flowchart for generating the text-based GUI prompt within a construction planning application that is executed by the computing platform.

5. The computing platform of claim 1, wherein the first user is a first construction-side user, and
the computing platform further comprising program instructions stored on the at least one non-transitory computer-readable medium that are executable by the at least one processor such that the computing platform is configured to:
cause the computing platform to present the first user with an input GUI program on the first client station, the input GUI program for receiving the incongruous rules as input incongruous rules, the incongruous data sets as input incongruous data sets, or combinations thereof, from the first user, each of the input incongruous rules and incongruous data sets associated with a construction project, and
receiving the input incongruous rules, input incongruous data sets, or combinations thereof from the first user via the input GUI program.

6. The computing platform of claim 5, wherein the second user is a platform-side user of the computing platform, and
the computing platform further comprising program instructions stored on the at least one non-transitory computer-readable medium that are executable by the at least one processor such that the computing platform is configured to:
store the logical flowchart on a user-generated flowchart database of the computing platform, and
utilizing, by the second user, the logical flowchart for generating another text-based GUI prompt within a construction planning application that is executed by the computing platform.

7. The computing platform of claim 5, wherein the second user is a second construction-side user of the computing platform, and
the computing platform further comprising program instructions stored on the at least one non-transitory computer-readable medium that are executable by the at least one processor such that the computing platform is configured to:
store the logical flowchart on a user-generated flowchart database of the computing platform, and
utilizing, by the second user, the logical flowchart for generating another text-based GUI prompt within a construction planning application that is executed by the computing platform.

8. The computing platform of claim 1, wherein the second user of the computing platform is a construction-side user of the computing platform, and
the computing platform further comprising program instructions stored on the at least one non-transitory computer-readable medium that are executable by the at least one processor such that the computing platform is configured to cause the second client station to present the second user with a workflow generation application,
wherein the program instructions that are executable by the at least one processor such that the computing platform is configured to cause the text-based GUI prompt to be presented to one or more of the user of the computing platform, another user of the computing platform, or combinations thereof is performed within the workflow generation application, and
wherein the output information is associated with a workflow for the construction task.

9. The computing platform of claim 1, wherein each of the at least one incongruous rule, the at least one incongruous data set, the initial condition, the response condition, the one or more datum, and the one or more second datum are associated with one or more of a geographical location for the construction task, a local jurisdiction for the construction task, or combinations thereof.

10. The computing platform of claim 9, wherein at least one of the at least one incongruous rule, the at least one incongruous data set, the initial condition, the response condition, the one or more datum, and the one or more second datum is associated with a local regulation of the local jurisdiction for the construction task.

11. The computing platform of claim 1, further comprising program instructions stored on the at least one non-transitory computer-readable medium that are executable by the at least one processor such that the computing platform is configured to:
tag each of the logical flowchart, the text-based GUI prompt, the user input, and the output information with an identifying tag associated with a known construction task,
store each of the logical flowchart, the text-based GUI prompt, the user input, and the output information, as tagged with the identifying tag associated with the known construction task, on a machine learning database, the machine learning database having stored thereon historical database contents associated with the known construction task, the database contents including one or more of historical logical flowcharts associated with the known construction task, historical text-based GUI prompts associated with the known construction task, historical user input associated with the known construction task, and historical output information associated with the known construction task, or combination thereof,
cause the computing platform to present the first user with a workflow generation application;
receive workflow input via the workflow generation application,
train a machine-learning model by carrying out a machine learning process on a training data set that includes the logical flowchart, the text-based GUI prompt, the user input, the output information, and the historical database contents, wherein the machine-learning model is configured to (i) cluster the logical flowchart, the text-based GUI prompt, the user input, the output information, and the historical database contents as a known construction task cluster, (ii) receive, as input, the workflow input, (iii) evaluate the workflow input by comparing the workflow input with the known construction task cluster, to determine if the workflow input is associated with the known construction task, (iv) if the evaluation determines that the workflow input is associated with the known construction task, select one or more of the text-based GUI prompt, one or more historical text-based GUI prompts, or combinations thereof for presentation to the user via the workflow generation application, and (v) if the evaluation determines that the workflow input is associated with the known construction task, store the workflow input on the machine-learning database, and
if the machine-learning model determines that the workflow input is associated with the known construction task, cause the computing platform to prompt the user with one or more of a suggested incongruous rule, a suggested incongruous data set, a suggested logical flowchart, a suggested text-based GUI prompt, or combinations thereof.

12. At least one non-transitory computer-readable medium, wherein the at least one non-transitory computer-readable medium is provisioned with program instructions that, when executed by at least one processor, cause a computing platform to:
generate a logical flowchart for a construction project task, the logical flowchart based on at least one incongruous rule and at least one incongruous data set, each incongruous rule comprising a respective initial condition and one or more respective response conditions, each of the respective initial condition and the one or more respective response conditions being one of previously received from a first client station associated with a first user, being previously input from the first client station or a second client station, being populated via current user input to the second client station, or combinations thereof, the at least one incongruous data set including one or more first datum and one or more second datum, each of the one or more first datum correlated with one of the one or more second datum, each of the one or more first datum, the one or more second datum, and correlations thereof being one of previously received from a first client station associated with a first user, being previously input from the first client station or a second client station, being populated via current user input to the second client station, or combinations thereof, each of the at least one incongruous rule, the at least one incongruous data set, the initial condition, the one or more response conditions, the one or more first datum, and the one or more second datum being associated with the construction project task;
generate a text-based graphical user interface (GUI) prompt based on the logical flowchart,
cause the text-based GUI prompt to be presented via one or more of the first client station, the second client station, or combinations thereof;
receive, from the first client station or the second client station, an indication of user input to the text-based GUI prompt;
cause the text-based GUI prompt to present output information, via the first client station, based on the logical flowchart and the user input; and
store, at least, the output information on at least one non-transitory computer readable medium of the computing platform.

13. The at least one non-transitory computer-readable medium of claim 11, wherein the second user of the computing platform is a construction-side user of the computing platform, and
wherein the at least one non-transitory computer-readable medium is also provisioned with program instructions that, when executed by at least one processor, cause the computing platform to cause the second client station to present the second user with a workflow generation application,
wherein the program instructions that, when executed by the at least one processor, cause the computing platform to cause the text-based GUI prompt to be presented to one or more of the user of the computing platform, another user of the computing platform, or combinations thereof is performed within the workflow generation application, and
wherein the output information is associated with a workflow for the construction task.

14. The at least one non-transitory computer-readable medium of claim 11, wherein each of the at least one incongruous rule, the at least one incongruous data set, the initial condition, the response condition, the one or more datum, and the one or more second datum are associated with one or more of a geographical location for the construction task, a local jurisdiction for the construction task, or combinations thereof.

15. The at least one non-transitory computer-readable medium of claim 14, wherein at least one of the at least one incongruous rule, the at least one incongruous data set, the initial condition, the response condition, the one or more datum, and the one or more second datum is associated with a local regulation of the local jurisdiction for the construction task.

16. The at least one non-transitory computer-readable medium of claim 11, wherein the at least one non-transitory computer-readable medium is also provisioned with program instructions that, when executed by at least one processor, cause the computing platform to:
tag each of the logical flowchart, the text-based GUI prompt, the user input, and the output information with an identifying tag associated with a known construction task;
store each of the logical flowchart, the text-based GUI prompt, the user input, and the output information, as tagged with the identifying tag associated with the known construction task, on a machine learning database, the machine learning database having stored thereon historical database contents associated with the known construction task, the database contents including one or more of historical logical flowcharts associated with the known construction task, historical text-based GUI prompts associated with the known construction task, historical user input associated with the known construction task, and historical output information associated with the known construction task, or combination thereof;
cause the computing platform to present the first user with a workflow generation application;
receive workflow input via the workflow generation application;
train a machine-learning model by carrying out a machine learning process on a training data set that includes the logical flowchart, the text-based GUI prompt, the user input, the output information, and the historical database contents, wherein the machine-learning model is configured to (i) cluster the logical flowchart, the text-based GUI prompt, the user input, the output information, and the historical database contents as a known construction task cluster, (ii) receive, as input, the workflow input, (iii) evaluate the workflow input by comparing the workflow input with the known construction task cluster, to determine if the workflow input is associated with the known construction task, (iv) if the evaluation determines that the workflow input is associated with the known construction task, select one or more of the text-based GUI prompt, one or more historical text-based GUI prompts, or combinations thereof for presentation to the user via the workflow generation application, and (v) if the evaluation determines that the workflow input is associated with the known construction task, store the workflow input on the machine-learning database; and
if the machine-learning model determines that the workflow input is associated with the known construction task, cause the computing platform to prompt the user with one or more of a suggested incongruous rule, a suggested incongruous data set, a suggested logical flowchart, a suggested text-based GUI prompt, or combinations thereof.

17. A method carried out by a computing platform, the method comprising:
generating a logical flowchart for a construction project task, the logical flowchart
based on at least one incongruous rule and at least one incongruous data set, each incongruous rule comprising a respective initial condition and one or more respective response conditions, each of the respective initial condition and the one or more respective response conditions being one of previously received from a first client station associated with a first user, being previously input from the first client station or a second client station, being populated via current user input to the second client station, or combinations thereof, the at least one incongruous data set including one or more first datum and one or more second datum, each of the one or more first datum correlated with one of the one or more second datum, each of the one or more first datum, the one or more second datum, and correlations thereof being one of previously received from a first client station associated with a first user, being previously input from the first client station or a second client station, being populated via current user input to the second client station, or combinations thereof, each of the at least one incongruous rule, the at least one incongruous data set, the initial condition, the one or more response conditions, the one or more first datum, and the one or more second datum being associated with the construction project task;
generating a text-based graphical user interface (GUI) prompt based on the logical flowchart;
causing the text-based GUI prompt to be presented via one or more of the first client station, the second client station, or combinations thereof;
receiving, from the first client station or the second client station, an indication of user input to the text-based GUI prompt;
causing the text-based GUI prompt to present output information, via the first client station, based on the logical flowchart and the user input; and
storing, at least, the output information on at least one non-transitory computer readable medium of the computing platform.

18. The method of claim 17, wherein at least one of the at least one incongruous rule, the at least one incongruous data set, the initial condition, the response condition, the one or more datum, and the one or more second datum is associated with a local regulation of the local jurisdiction for the construction task.

19. The method of claim 18, wherein at least one of the at least one incongruous rule, the at least one incongruous data set, the initial condition, the response condition, the one or more datum, and the one or more second datum is associated with a local regulation of the local jurisdiction for the construction task.

20. The method of claim 17, further comprising:
tagging each of the logical flowchart, the text-based GUI prompt, the user input, and the output information with an identifying tag associated with a known construction task;
storing each of the logical flowchart, the text-based GUI prompt, the user input, and the output information, as tagged with the identifying tag associated with the known construction task, on a machine learning database, the machine learning database having stored thereon historical database contents associated with the known construction task, the database contents including one or more of historical logical flowcharts associated with the known construction task, historical text-based GUI prompts associated with the known construction task, historical user input associated with the known construction task, and historical output information associated with the known construction task, or combination thereof;
causing the computing platform to present the first user with a workflow generation application;
receiving workflow input via the workflow generation application;
training a machine-learning model by carrying out a machine learning process on a training data set that includes the logical flowchart, the text-based GUI prompt, the user input, the output information, and the historical database contents, wherein the machine-learning model is configured to (i) cluster the logical flowchart, the text-based GUI prompt, the user input, the output information, and the historical database contents as a known construction task cluster, (ii) receive, as input, the workflow input, (iii) evaluate the workflow input by comparing the workflow input with the known construction task cluster, to determine if the workflow input is associated with the known construction task, (iv) if the evaluation determines that the workflow input is associated with the known construction task, select one or more of the text-based GUI prompt, one or more historical text-based GUI prompts, or combinations thereof for presentation to the user via the workflow generation application, and (v) if the evaluation determines that the workflow input is associated with the known construction task, store the workflow input on the machine-learning database; and
if the machine-learning model determines that the workflow input is associated with the known construction task, cause the computing platform to prompt the user with one or more of a suggested incongruous rule, a suggested incongruous data set, a suggested logical flowchart, a suggested text-based GUI prompt, or combinations thereof.
